(19) United States
(12) Patent Application Publication
(10) Pub. No.: US 2008/0279081 A1
(43) Pub. Date: Nov. 13, 2008

(54) Optical Device for Recording and Reproducing

(75) Inventors: Petrus Jutte, Eindhoven (NL); Johannes De Wit, Helmond (NL)

Correspondence Address: BAINWOOD HUANG & ASSOCIATES LLC, 2 CONNECTOR ROAD, WESTBOROUGH, MA, 01581, US

(73) Assignee: Arima Devices Corporation, Road Town, Tortola (VG)

(21) Appl. No.: 11/631,352

(22) PCT Filed: Jun. 22, 2005
(86) PCT No.: PCT/IB2005/052047

§ 371 Date: Jan. 16, 2008

(30) Foreign Application Priority Data
Jul. 2, 2004 (EP) 04300421.7
Jul. 12, 2004 (EP) 04300441.5

(51) Int. Cl. G11B 7/002

(52) U.S. Cl. 369/100

(57) ABSTRACT

An optical device compatible with at least three different types of information carrier. It comprises a main optical branch comprising detecting means (203), a collimator (201), a first beam splitter (214) at a first distance d1 from the collimator, a second beam splitter (224) at a second distance d2 from the collimator and a third beam splitter (234) at a third distance d3 from the collimator. It also comprises, located substantially perpendicular to the main optical branch—a first optical branch for scanning an information carrier with a first numerical aperture NA1; the first optical branch comprises a first radiation source (211), a first pre-collimator (212) and the first beam splitter (214); —a second optical branch for scanning an information carrier with a second numerical aperture NA2; the second optical branch comprises a second radiation source (221), a second pre-collimator (222) and the second beam splitter (224); —a third optical branch for scanning an information carrier with a third numerical aperture NA3; the third optical branch comprises a third radiation source (231), a beam shaper (232) and the third beam splitter (233); In this optical scanning device, d1>d2>d3 and NA2<NA1<NA3.

### FIELD OF THE INVENTION

The present invention relates to an optical scanning device for scanning different types of information carrier.

The present invention is particularly relevant for an optical disc apparatus for recording to and reading from a CD, a DVD and a Blu-Ray Disc (BD).

### BACKGROUND OF THE INVENTION

Different types of optical scanning device have been developed recently. In order to increase the data capacity, the wavelength of the scanning beam is more and more reduced, whereas the numerical aperture of the scanning beam is more and more increased. For example, in a CD recorder, the wavelength of the scanning beam is 785 nanometers and the numerical aperture is 0.5. In a DVD recorder, the wavelength of the scanning beam is 650 nanometers and the numerical aperture is 0.65. In a BD recorder, the wavelength of the scanning beam is 405 nanometers and the numerical aperture is 0.85. It is important that a new optical scanning device is compatible with old information carriers, such that a user buying a new optical scanning device can still read his old information carriers. For example, a DVD player should be able to play DVDs and CDs, and a BD player should be able to play BDs, DVDs and CDs.

An optical scanning device that is able to scan a BD, a DVD and a CD is described in a paper from Nikkei Electronics (2003.05.12), p 119-p 133, “Part 4: the Key Technologies of Blu-ray”, by Kiyoshi Osato, Tadashi Taniguchi, Masao Ikeda, Masahiro Katsumura, Tetsuya Imai, Eiji Ohno, Naoyasu Miayakwa, Masashi Furumiya and Atsushi Nakamura. Such an optical scanning device is shown in FIG. 1. It comprises a DVD source 101, a first half mirror 102, a CD source 103, a first collimator 104, a second half mirror 105, a BD source 106, a beam shaper 107, a polarizing beam splitter 108, a second collimator 109, a folding mirror 110, a quarter wave plate 111, an objective lens 112, a servo lens 113 and detecting means 114. This optical scanning device is intended to scan an information carrier 100. This information carrier 100 can be of the CD, the DVD or the BD type.

When a BD is scanned, the BD source 106 is powered and generates a polarized BD radiation beam. As a certain rim intensity is required on the information carrier 100, the BD radiation beam is circularized by means of the beam shaper 107. It then passes through the polarizing beam splitter 108, and is then collimated by means of the second collimator 109. The collimated BD radiation beam is then deflected by the second half mirror 105, and directed towards the information carrier 100 by means of the folding mirror 110. It is finally focused on the information carrier 100 by means of the objective lens 112. On the way back from the information carrier, the BD radiation beam is deflected by the second half mirror 105, then focused on the detecting means 114 by means of the second collimator 109, the polarizing beam splitter 108 and the servo lens 113. The polarizing beam splitter 108 here deflects the BD radiation beam towards the detecting means 114, because the reflected BD radiation beam has a polarization orthogonal to the polarization of the radiation beam generated by the BD radiation source 106, due to the presence of the quarter wave plate 111 in the optical path.

When a DVD is scanned, the DVD source 101 is powered and generates a polarized DVD radiation beam, which passes through the first half mirror 102, is collimated by means of the first collimator 104 and then passes through the second half mirror 105. The DVD radiation beam then follows the same path as the BD radiation beam after the second half mirror 105. The reflected DVD radiation beam is detected by means of the detecting means 114, as described for the BD radiation beam. When a CD is scanned, the CD source 103 is powered and generates a polarized CD radiation beam, which is deflected by the first half mirror 102 towards the first collimator 104, is collimated by means of the first collimator 104 and then passes through the second half mirror 105. The CD radiation beam then follows the same path as the BD radiation beam after the second half mirror 105. The reflected CD radiation beam is detected by means of the detecting means 114, as described for the BD radiation beam.

A drawback of such an optical scanning device is that it requires two collimators. This makes such an optical scanning device bulky, complicated and difficult to assemble.

### SUMMARY OF THE INVENTION

It is an object of the invention to provide an optical scanning device that is able to scan at least three different types of information carriers, which optical scanning device comprises only one collimator.

To this end, the invention proposes an optical device comprising a main optical branch comprising detecting means, a collimator, a first beam splitter at a first distance d1 from the collimator, a second beam splitter at a second distance d2 from the collimator and a third beam splitter at a third distance d3 from the collimator, and, located substantially perpendicular to the main optical branch, a first optical branch for scanning an information carrier with a first numerical aperture NA1, said first optical branch comprising a first radiation source, a first pre-collimator and the first beam splitter; a second optical branch for scanning an information carrier with a second numerical aperture NA2, said second optical branch comprising a second radiation source, a second pre-collimator and the second beam splitter; a third optical branch for scanning an information carrier with a third numerical aperture NA3, said third optical branch comprising a third radiation source, a beam shaper and the third beam splitter; wherein d1>d2>d3 and NA2<NA1<NA3.

As will be explained in details in the description, this configuration allows to use only one collimator for the three radiation beams. For example, the first optical branch is intended to scan a DVD, with a numerical aperture NA1=0.65, the second optical branch is intended to scan a CD, with a numerical aperture NA2=0.5, and the third optical branch is intended to scan a BD, with a numerical aperture NA3=0.85. According to the invention, the DVD branch is more remote from the collimator than the CD branch, which is more remote from the collimator than the BD branch.

Advantageously, the second optical branch is located on the other side of the main optical branch with respect to the first and third optical branches. This saves space for the holders of the different elements of the first and third optical branches. This thus simplifies the assembly process of such an optical scanning device.

### BRIEF DESCRIPTION OF THE DRAWINGS

The invention will now be described in more detail by way of example with reference to the accompanying drawings, in which:

FIG. 1 shows an optical scanning device in accordance with the prior art;

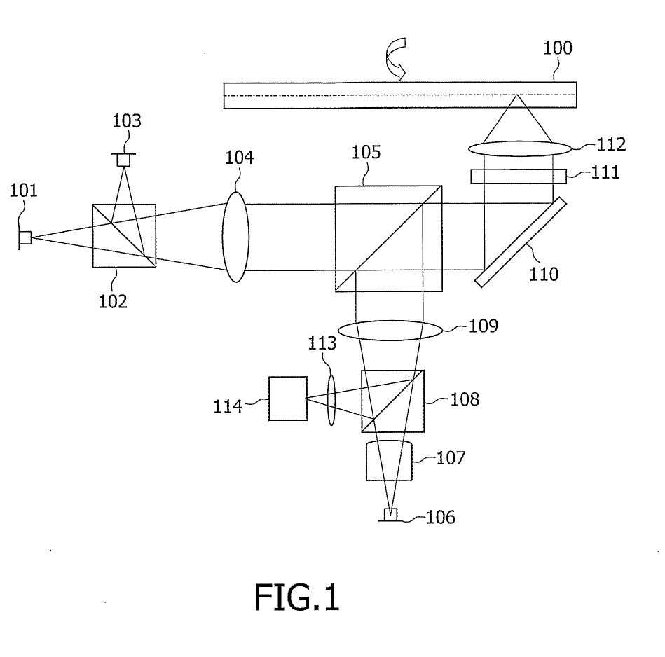

FIG. 2 shows an optical scanning device in accordance with the invention.

### DETAILED DESCRIPTION OF THE INVENTION

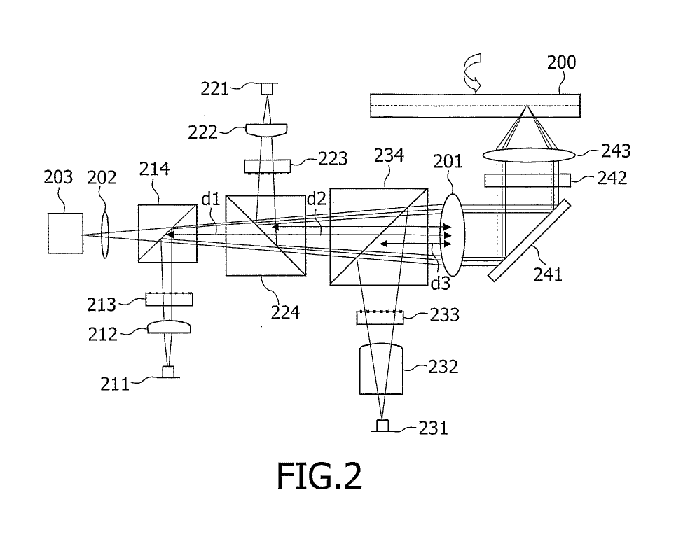

An optical scanning device in accordance with the invention is depicted in FIG. 2. This optical scanning device comprises a collimator 201, a servo lens 202, detecting means 203, a first radiation source 211, a first pre-collimator 212, a first grating 213, a first polarizing beam splitter 214, a second radiation source 221, a second pre-collimator 222, a second grating 223, a second polarizing beam splitter 224, a third radiation source 231, a beam shaper 232, a third grating 233, a third polarizing beam splitter 234, a folding mirror 241, a quarter wave plate 242 and an objective lens 243. This optical scanning device is intended to scan an information carrier 200 which can be of a first, a second or a third type.

The collimator 201 and the detecting means 203 form a main optical branch, which also comprises the first polarizing beam splitter 214, the second polarizing beam splitter 224 and the third polarizing beam splitter 234. In this example, the main optical branch also comprises the servo lens 202, which is used for introducing astigmatism in the radiation beam before it reaches the detector, in order to measure a focus error signal. The servo lens 202 can be omitted if another focus detection method is used.

The first radiation source 211, the first pre-collimator 212, the first grating 213 and the first polarizing beam splitter 214 form a first optical branch, which is substantially orthogonal to the main optical branch. This means that the minimum angle between the main optical branch and the first optical branch is larger than 60 degrees, preferably more than 80 degrees. It should be noted that the first polarizing beam splitter 214 belongs to the main optical branch and to the first optical branch. The second radiation source 221, the second pre-collimator 222, the second grating 223 and the second polarizing beam splitter 224 form a second optical branch, which is substantially orthogonal to the main optical branch. The second polarizing beam splitter 224 belongs to the main optical branch and to the second optical branch. The third radiation source 231, the beam shaper 232, the third grating 233 and the third polarizing beam splitter 234 form a third optical branch, which is substantially orthogonal to the main optical branch. The third polarizing beam splitter 234 belongs to the main optical branch and to the third optical branch.

The first, second and third gratings 213, 223 and 233 are used for generating three spots from the radiation beam generated by the first radiation source 211, the second radiation source 221 and the third radiation source 231, respectively. The three spots are used for tracking purpose, for example by means of the so-called three-spots push pull or differential push pull tracking method. If another tracking method is used, the first, second and third gratings 213, 223 and 233 can be omitted.

Although the beam splitters 214, 224 and 234 of FIG. 2 are polarizing beam splitters, the invention also applies to an optical scanning device comprising non-polarizing beam splitters, or a combination of polarizing beam splitters and non-polarizing beam splitters. The use of polarizing beam splitters is advantageous, because it increases the power on the information carrier.

In the following example, the first optical branch is intended to scan a DVD with a numerical aperture of 0.65, the second optical branch is intended to scan a CD with a numerical aperture of 0.5 and the third optical branch is intended to scan a BD with a numerical aperture of 0.85. However, the invention is not limited to these types of information carrier.

Because of the required rim intensity of the BD radiation beam and the required power on the information carrier 200, a beam shaper 233 is required in the BD optical branch, i.e. the third optical branch. For example, a beam shaper such as the one described in patent EP0605923 may be used in the BD branch. A beam shaper is usually relatively large, such that the size of the third optical branch is relatively large. Now, the distance between the third radiation source 231 and the collimator 201 is fixed, and is equal to the focal distance fc of the collimator 201. This means that the distance d1 between the third polarizing beam splitter 234 and the collimator 201 should be relatively small. This can be achieved in that the third optical branch is the closest branch to the collimator 201.

In order to have enough power on the information carrier 200 when a DVD is scanned, a pre-collimator has to be used in the first optical branch. Actually, without any pre-collimator in the first optical branch, the numerical aperture of the DVD beam is limited by the numerical aperture of the BD beam, i.e. the numerical aperture of the collimator 201. As a consequence, a relatively small portion of the DVD radiation beam at the exit of the DVD radiation source 211 reaches the information carrier 200. The first pre-collimator 212 allows increasing the coupling numerical aperture of the DVD radiation beam, i.e. the portion of the DVD radiation beam that will reach the information carrier 200. This also applies to the CD radiation beam. The second pre-collimator 222 allows increasing the coupling numerical aperture of the CD radiation beam. The first pre-collimator 212 has a magnification m_{DVD}

$$defined by m DVD = \frac{diam ( B D )}{diam ( DVD )} * \frac{coupling N A ( DVD )}{coupling N A ( B D )} ,$$

where diam(BD), is the diameter of the parallel radiation beam and diam(DVD) the diameter of the DVD radiation beam, couplingNA(DVD) is the coupling numerical aperture of the DVD radiation beam and couplingNA(BD) is the coupling numerical aperture of the BD radiation beam. The second pre-collimator 222 has a magnification m_{CD} defined by

$$m CD = \frac{diam ( B D )}{diam ( CD )} * \frac{coupling N A ( CD )}{coupling N A ( B D )} .$$

As the coupling NA of the CD radiation beam should be preferably higher than the coupling NA of the DVD radiation beam, in order to get substantially the same amount of power on the information carrier 200 when a CD and a DVD is scanned, and as the diameter of the DVD radiation beam is larger than the diameter of the CD radiation beam, the magnification m_{CD} of the second pre-collimator 222 is larger than the magnification m_{DVD} of the first pre-collimator 212.

Now, the first pre-collimator 212 shortens the optical path from the first radiation source 211 to the information carrier 200 with a value Δ1_{DVD}=O₁*(m_{DVD}−1), where O₁ is the optical distance between the first radiation source 211 and the first pre-collimator 212, which depends on the housing dimensions of the first radiation source 211. In the same way, the second pre-collimator 222 shortens the optical path from the second radiation source 221 to the information carrier 200 with a value Δ1_{CD}=O₂*(M_{CD}−1), where O₂ is the optical distance between the second radiation source 221 and the second pre-collimator 222, which depends on the housing dimensions of the second radiation source 221. As the first and second radiation sources 211 and 221 are physically similar, the optical distance O₁ is substantially equal to the optical distance O₂. As a consequence, the value Δ1_{CD} is superior to the value Δ1_{DVD}. The optical path from the second radiation source 221 to the collimator 201 should thus be inferior to the optical path from the first radiation source 211 to the collimator 201. This can be achieved in that the first optical branch is the most remote branch from the collimator 201.

As a consequence, an optical scanning device compatible with at least three different types of information carrier can be designed with a single detector. To this end, the optical branch for scanning an information carrier with the highest numerical aperture should be the closest to the collimator, the optical branch for scanning an information carrier with the smallest numerical aperture should be more remote from the collimator and the optical branch for scanning an information carrier with the intermediate numerical aperture should be the most remote from the information carrier.

In the example of FIG. 2, the second optical branch is located on the other side of the main optical branch with respect to the first and third optical branches. Although the three optical branches could be placed on the same side of the main optical branch, the configuration of FIG. 2 is particularly advantageous. Actually, when the second optical branch is placed on a different side of the main optical branch with respect to the two other optical branches, space is saved between the first and third branches. This space can be used for the holders of the different elements of the first and third branches, as well as for the electrical connections of the first and third radiation sources 211 and 231. This limits the length of the electrical connections between the integrated circuit that controls the first and third radiation sources 211 and 231 and said radiation sources. This is particularly advantageous when the first radiation source 211 is a DVD radiation source and the third radiation source 231 is a BD radiation source, because in these two cases the length of said electrical connections is critical.

An example of dimensions of an optical scanning device in accordance with the invention is given hereinafter. The width of the first, second and third polarizing beam splitter is about 5 millimeters. Hence, an optical branch can be placed at a distance equal to 15 mm from the collimator 201, another optical branch at a distance equal to 10 mm and another optical branch at a distance equal to 5 mm. Due to the relatively large beam shaper 232, the distance between the third radiation source 231 and the third polarizing beam splitter 234 is 15 millimeters. The focal length of the collimator 201 is 22 millimeters. As a consequence, the third optical branch can only be placed at the distance equal to 5 mm from the collimator 201.

The numerical aperture of the second optical branch is 0.5 and the numerical aperture of the third optical branch is 0.85. It can then be calculated, with a coupling numerical aperture of 0.12 for the second optical branch, that the optical distance between the second radiation source 221 and the collimator 201 is f_{C}−Δ1_{CD}=19 millimeters. Now, the distance between the second radiation source 221 and the second polarizing beam splitter 224 is equal to 8 millimeters. As a consequence, the second optical branch can only be placed at the distance equal to 10 mm from the collimator 201. Then the first optical branch has to be placed at the distance equal to 10 mm from the collimator 201.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a main optical branch comprising detecting means (203), a collimator (201), a first beam splitter (214) at a first distance d1 from the collimator, a second beam splitter (224) at a second distance d2 from the collimator and a third beam splitter (234) at a third distance d3 from the collimator, and, located substantially perpendicular to the main optical branch,
a first optical branch for scanning an information carrier with a first numerical aperture NA1, said first optical branch comprising a first radiation source (211), a first pre-collimator (212) and the first beam splitter (214);
a second optical branch for scanning an information carrier with a second numerical aperture NA2, said second optical branch comprising a second radiation source (221), a second pre-collimator (222) and the second beam splitter (224);
a third optical branch for scanning an information carrier with a third numerical aperture NA3, said third optical branch comprising a third radiation source (231), a beam shaper (232) and the third beam splitter (233); wherein d1>d2>d3 and NA2<NA1<NA3.

2. An optical scanning device as claimed in claim 1, wherein the second optical branch is located on the other side of the main optical branch with respect to the first and third optical branches.

3. An optical scanning device as claimed in claim 1, wherein the first optical branch is intended to scan a DVD, the second optical branch is intended to scan a CD and the third optical branch is intended to scan a BD.
